(19) United States
(12) Patent Application Publication
(10) Pub. No.: US 2026/0093108 A1
(43) Pub. Date: Apr. 2, 2026

(54) CAPSULE ENDOSCOPE OPTICAL LENS ASSEMBLY

(71) Applicant: Changzhou AAC Raytech Optronics Co., Ltd., Changzhou City (CN)

(72) Inventor: Jin Li, Changzhou (CN)

(21) Appl. No.: 18/979,699

(22) Filed: Dec. 13, 2024

Related U.S. Application Data
(63) Continuation of application No. PCT/CN2024/122705, filed on Sep. 30, 2024.

(51) Int. Cl. G02B 23/24

(52) U.S. Cl. CPC G02B 23/243

(57) ABSTRACT

A capsule endoscope optical lens assembly is provided, and includes the optical lens, the imaging surface provided on the image side of the optical lens, and the optical filter provided between the imaging surface and the optical lens. The optical lens includes the lens barrel and the plurality of lenses arranged in sequence from the object side to the image side, which are housed within the lens barrel. The plurality of lenses include the first lens located near the object side, the second lens located near the image side, and the at least one third lens located between the first lens and the second lens. The second lens is the glass lens, and the lens barrel includes the annular barrel wall. The first lens and the barrel wall are fixedly connected by black glue.

### CROSS REFERENCE TO RELATED APPLICATIONS

The present application is a continuation of PCT Patent Application No. PCT/CN2024/122705, filed September 30, 2024, which is incorporated by reference herein in its entirety.

### TECHNICAL FIELD

The various embodiments described in this document relate in general to the technical field of optical imaging, and more specifically to a capsule endoscope optical lens assembly.

### BACKGROUND

In the related technologies, an optical lens assembly of a capsule endoscope generally adopts several pure plastic lenses, which are stacked and then assembled into a lens barrel. Since the optical system has a large field of view, a diameter of a first lens close to an object side is much larger than that of the last few lenses, which leads to the overall size of the lens. In the existing technologies, a size of at least one lens near the image side can be reduced starting from the first of the at least one lens near the image side in an assembly order of lenses. However, a size of at least one lens near the object side is still limited due to the addition of a pressing ring to fix the lens and to block stray light.

In the related technologies, pure plastic lenses are adopted, and imaging performance, aperture, and angle of view of the pure plastic lens cannot be better due to the limitation of the shape and size. In addition, due to the existence of the pressing ring, a size of a front end of the optical lens assembly of the capsule endoscope is limited and cannot be smaller.

Therefore, it is necessary to provide a capsule endoscope optical lens assembly to solve the above-described technical problems.

### SUMMARY

The purpose of the present disclosure is to provide a capsule endoscope optical lens assembly, which aims to solve the problem that the size of the object side end of the traditional capsule endoscope optical lens assembly is large and the cost is high.

In view of the above, the present disclosure provides a capsule endoscope optical lens assembly, which includes an optical lens, an imaging surface provided on an image side of the optical lens, and an optical filter provided between the imaging surface and the optical lens. The optical lens includes a lens barrel and a plurality of lenses that are arranged sequentially from an object side to the image side of the optical lens and received in the lens barrel. The plurality of lenses include a first lens close to the object side, a second lens close to the image side, and at least one third lens provided between the first lens and the second lens. The second lens is a glass lens. The lens barrel includes an annular barrel wall, and the first lens is fixedly connected to the barrel wall by black glue.

In some embodiments, the first lens includes an optical portion located in a middle region of the first lens and a carrier portion disposed around the optical portion, where an effective diameter of the optical portion is larger than a length of a diagonal of the imaging surface.

In some embodiments, an outer diameter of the first lens, an outer diameter of the third lens, and an outer diameter of the second lens gradually decrease in a direction from the object side to the image side.

In some embodiments, the lens barrel further includes a support wall formed by bending and extending from an end of the barrel wall close to the image side, the barrel wall defines a first light passing hole at an end of the barrel wall close to the object side, and the support wall defines a second light passing hole.

In some embodiments, the second lens is supported on the support wall.

In some embodiments, at least one fourth lens is provided between the first lens and the third lens.

In some embodiments, the optical lens includes at least two glass lenses.

In some embodiments, a light shielding sheet is provided between at least two adjacent lenses.

In some embodiments, the second lens is provided with a chamfer at a periphery of a surface of the second lens close to the image side.

Compared with the related technologies, the present disclosure provides the capsule endoscope optical lens assembly, which includes the optical lens, the imaging surface provided on the image side of the optical lens, and the optical filter provided between the imaging surface and the optical lens. The optical lens includes the lens barrel and the plurality of lenses arranged in sequence from the object side to the image side, which are received in the lens barrel. The plurality of lenses include the first lens located near the object side, the second lens located near the image side, and the at least one third lens located between the first lens and the second lens. The second lens is the glass lens, and the lens barrel includes the annular barrel wall. The first lens and the barrel wall are fixedly connected by black glue. In the present disclosure, the lens in the plurality of lenses closest to the image side is provided as the glass lens, so that the imaging performance of the whole capsule endoscope optical lens assembly is better, and the aperture and the field of view can be larger. In addition, the lens in the plurality of lenses closest to the object side is fixed to the lens barrel by black glue, eliminating the pressing ring, which can effectively block stray light and reduce costs.

### BRIEF DESCRIPTION OF THE DRAWINGS

FIG. 1 is a schematic cross-sectional view of a capsule endoscope optical lens assembly according to the present disclosure.

### DETAILED DESCRIPTION OF THE EMBODIMENTS

The technical solutions in the embodiments of the present disclosure will be clearly and completely described below in combination with the drawings in the embodiments of the present disclosure. Obviously, the described embodiments are merely some embodiments of the present disclosure, rather than all embodiments. Based on the embodiments in the present disclosure, all other embodiments obtained by ordinary skilled personnel in the art without making creative effort belong to the scope of protection of the present disclosure.

The capsule endoscope optical lens assembly is different from a conventional optical lens for mobile phones. In the capsule endoscope optical lens assembly, a lens closest to the object side is larger than other lenses, so the overall structure of the capsule endoscope optical lens assembly is different from that of the conventional lens for the mobile phone.

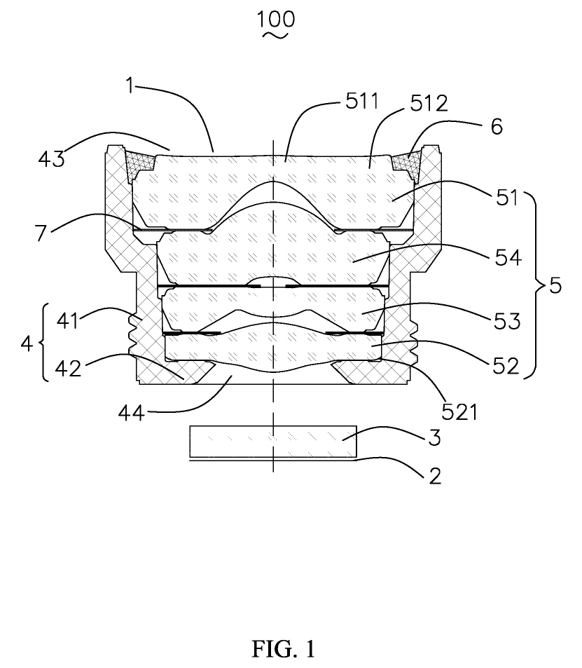

Embodiments of the present disclosure provide a capsule endoscope optical lens assembly 100. As shown in FIG. 1, the capsule endoscope optical lens assembly 100 includes: an optical lens 1, an imaging surface 2 disposed on a side of the optical lens 1, and an optical filter 3 disposed between the imaging surface 2 and the optical lens 1. The optical filter 3 may be an infrared optical filter, so that the capsule endoscope optical lens assembly 100 can filter out infrared light, prevent the infrared light from reaching the imaging surface 2 and avoiding causing interference with normal visible light for imaging, thereby improving the imaging quality.

The optical lens 1 includes an object side and an image side disposed opposite each other in an optical axis direction. The optical lens 1 includes a lens barrel 4 and a plurality of lenses 5 accommodated in the lens barrel 4 and arranged sequentially from the object side to the image side.

The lens barrel 4 includes an annular barrel wall 41 and a support wall 42 formed by bending and extending from an end of the barrel wall 41 close to the image side. The barrel wall 41 defines a first light passing hole 43 at an end of the barrel wall 41 close to the object side, and the support wall 42 defines a second light passing hole 44.

The plurality of lenses 5 include at least a first lens 51 close to the object side, a second lens 52 close to the image side, and at least one third lens 53 provided between the first lens 51 and the second lens 52. In the present embodiment, the plurality of lenses 5 include four lenses, specifically, including a first lens 51, a fourth lens 54, a third lens 53, and a second lens 52 arranged in this order in a direction from the object side to the image side. An outer diameter of the first lens 51, an outer diameter of the fourth lens 54, an outer diameter of the third lens 53, and an outer diameter of the second lens 52 gradually decrease. In other embodiments, the plurality of lenses 5 may also include other numbers of lenses according to actual needs.

It shall be understood that the outer diameter of the lens refers to a maximum outer-contour diameter of the circular part of the lens. For a circular lens, the outer diameter refers to a length of a longest line segment that passes through the center of the lens and connects two points on the circumference of the lens. If the lens is square-shaped or of other shapes, the concept of the outer diameter may vary according to the actual situation. For example, for a square lens, the outer diameter may refer to a diameter of a circumcircle of the square lens, or a maximum length in a specific direction (such as a diagonal direction).

In the present embodiment, the first lens 51 is a lens closest to the object side. The first lens 51 and the barrel wall 41 of the lens barrel 4 are fixedly connected by the black glue 6. Such fixing manner can eliminate the pressing ring for fixing the lens, so that the head size of the optical lens can be effectively reduced. In addition, stray light can be effectively blocked, and the cost is also reduced. The second lens 52 is a glass lens, and the second lens 52 is supported on the support wall 42. The second lens 52 closest to the image side is provided as a glass lens, so that the optical performance of the optical lens 1 can be better, and the aperture and the field of view can be made larger under the same outer shape and the sizes. A periphery of a surface of the second lens 52 close to the image side is provided with a chamfer 521, and the chamfer 521 can avoid interference with the lens barrel 4 during assembling of the lens, and facilitates assembly.

The first lens 51 includes an optical portion 511 located in a middle region of the first lens 51 and a carrier portion 512 provided around the optical portion 511. The imaging surface 2 has a rectangular shape. An effective diameter of the optical portion 511 is larger than a length of a diagonal of the imaging surface 2.

It shall be understood that the effective diameter of the lens refers to an effective diameter range in which the lens actually participates in an imaging process in an optical system. The effective diameter determines a range through which light can pass through the lens and influences characteristics such as the quality and brightness of the imaging.

In some embodiments, the optical lens 1 includes at least two pieces of glass lenses. Since the lens made of plastic material can reduce the quality of the optical lens 1, the burden of the driving mechanism in the optical lens 1 can also be reduced, which may be conducive to reducing the volume of the driving mechanism, and may further reduce the volume of the optical lens assembly. In this way, it is possible to conform to the trend of miniaturization of the lens assembly in the market. In addition, the optical performance of the glass lens is more excellent, and therefore, it is important to reasonably allocate the number of plastic lenses and the number of glass lenses.

The optical lens 1 of the present disclosure further includes at least one light shielding sheet 7, where each of the at least one light shielding sheet 7 is disposed between a corresponding pair of two adjacent lenses 5. Each of the at least one light shielding sheet 7 can adjust the air interval between the two adjacent lenses 5 according to a thickness of the light shielding sheet 7, and can play the role of absorbing stray light.

Compared with the related technologies, the present disclosure provides the capsule endoscope optical lens assembly, which includes the optical lens, the imaging surface provided on the image side of the optical lens, and the optical filter provided between the imaging surface and the optical lens. The optical lens includes the lens barrel and the plurality of lenses arranged in sequence from the object side to the image side, which are received within the lens barrel. The plurality of lenses include the first lens located near the object side, the second lens located near the image side, and the at least one third lens located between the first lens and the second lens. The second lens is the glass lens, and the lens barrel includes the annular barrel wall. The first lens and the barrel wall are fixedly connected by black glue. In the present disclosure, the lens closest to the image side is provided as the glass lens, so that the imaging performance of the whole capsule endoscope optical lens assembly is better, and the aperture and the field of view can be larger. In addition, the lens closest to the object side is fixed to the lens barrel by black glue, eliminating the pressing ring, which can effectively block stray light and reduce costs.

The above is merely some embodiment of the present disclosure, here it shall be pointed out that for ordinary skilled personnel in the art, without departing from the concept of creation of the present disclosure, improvements can also be made, but these belong to the scope of protection of the present disclosure.

What is claimed is:

1. A capsule endoscope optical lens assembly, comprising:
an optical lens, an imaging surface provided on an image side of the optical lens, and an optical filter provided between the imaging surface and the optical lens, wherein the optical lens includes:
a lens barrel and a plurality of lenses arranged sequentially from an object side of the optical lens to the image side and received in the lens barrel, wherein the plurality of lenses include a first lens close to the object side, a second lens close to the image side, and at least one third lens provided between the first lens and the second lens;
wherein the second lens is a glass lens, the lens barrel includes an annular barrel wall, and the first lens is fixedly connected to the barrel wall by black glue.

2. The capsule endoscope optical lens assembly of claim 1, wherein the first lens includes an optical portion located in a middle region of the first lens and a carrier portion disposed around the optical portion, wherein the optical portion has an effective diameter larger than a length of a diagonal of the imaging surface.

3. The capsule endoscope optical lens assembly of claim 2, wherein an outer diameter of the first lens, an outer diameter of the third lens, and an outer diameter of the second lens gradually decrease in a direction from the object side to the image side.

4. The capsule endoscope optical lens assembly of claim 1, wherein the lens barrel further comprises a support wall formed by bending and extending from an end of the barrel wall close to the image side, the barrel wall defines a first light passing hole at an end of the barrel wall close to the object side, and the support wall defines a second light passing hole.

5. The capsule endoscope optical lens assembly of claim 4, wherein the second lens is supported on the support wall.

6. The capsule endoscope optical lens assembly of claim 1, wherein at least one fourth lens is provided between the first lens and the third lens.

7. The capsule endoscope optical lens assembly of claim 1, wherein the optical lens includes at least two glass lenses.

8. The capsule endoscope optical lens assembly of claim 1, wherein a light shielding sheet is provided between at least two adjacent lenses.

9. The capsule endoscope optical lens assembly of claim 1, wherein the second lens is provided with a chamfer at a periphery of a surface of the second lens close to the image side.
